(19) United States
(12) Patent Application Publication
(10) Pub. No.: US 2002/0009988 A1
(43) Pub. Date: Jan. 24, 2002

(54) Propitious information distribution system using a wireless mobile terminal

(76) Inventor: Kunio Murata, Koyoen Nishinomiya-city (JP)

Correspondence Address: CISLO & THOMAS, LLP, 233 WILSHIRE BLVD, SUITE 900, SANTA MONICA, CA, 90401-1211, US

(21) Appl. No.: 09/900,292

(22) Filed: Jul. 6, 2001

(30) Foreign Application Priority Data
Jul. 7, 2000 (JP) 2000-207004

(51) Int. Cl. H04M 3/42

(52) U.S. Cl. 455/414; 455/566

(57) ABSTRACT

A propitious information distribution system for delivering information related to worship practices including charms, messages, prayers, and fortunes, using a wireless terminal, is provided. The system simulates of a visit to a worship place whereby the worshiper acquires a charm, prayer, fortune telling information, purification information, or other information associated with the worship practice. The system also allows for the simulation of a marriage using a wireless terminal.

### CROSS-REFERENCES TO RELATED APPLICATIONS

This patent application claims priority from Japan Patent Application No. 2000-207004 filed on Jul. 7, 2000.

### BACKGROUND OF THE INVENTION

1. Field of the Invention

The present invention relates to an information distribution system using a wireless mobile terminal, and, more particularly to a propitious information distribution system, simulating an actual visit to a place of worship.

2. Description of the Related Art

In recent years, the degree of technological progress of portable terminal units, such as portable telephones and personal handy-phone system (PHS) has been remarkable, and accordingly, use of portable units have increased rapidly surpassing use of the fixed telephone, also known as subscriber telephones. With this rapid increase in portable terminal units, information services utilizing such units have been invented for various practical uses.

Presently, prayers such as for safe delivery of a baby, traffic safety, passing an examination and good business, among others are implemented in shrines or temples, and a believer needs to visit such a facility every time he wishes to acquire a prayer, or a charm associated with the prayer (“propitious information”). According to some practices, a given charm needs to be renewed annually, by returning the old charm given and getting a new charm from the shrine or temple. However, it is difficult for many people to visit the shrine or temple to renew their charms, especially for pregnant women and sick people believe that they need these charms more than healthy people do.

### SUMMARY OF THE INVENTION

The present invention offers a system for the distribution of propitious information such as prayer or a lucky charm using a wireless mobile terminal, for simulating an actual visit to a worship place such as shrine or temple. This may be useful for sick, injured and pregnant people who may feel that they need to visit the temple the most, but may have a difficult time traveling. The invention also offers a system for simulating other experiences related to worship activities including fortune telling, and simulating a marriage using a wireless terminal.

### OBJECTS OF THE INVENTION

It is an object of the present invention to provide a propitious information distribution system using a wireless mobile terminal, for simulating an actual visit to a worship place such as shrine or temple.

These and other objects and advantages of the present invention will be apparent from a review of the following specification and accompanying drawings.

### BRIEF DESCRIPTION OF THE DRAWINGS

FIG. 1 is a system configuration diagram illustrating the operation of a propitious information distribution system using a wireless mobile terminal according to a preferred embodiment of the present invention.

FIG. 2 is a block diagram for an information serving terminal suitable for the system of FIG. 1.

FIG. 3 is a block diagram for a circuit of an information serving terminal suitable for the system of FIG. 1.

FIG. 4 is a block diagram of an intermediate server suitable for the system of FIG. 1.

FIG. 5 is a block diagram of a circuit for an intermediate server suitable for the system of FIG. 1.

FIG. 6 is a block diagram of a wireless mobile terminal suitable for the system of FIG. 1.

FIG. 7 is a block diagram of a circuit for a wireless mobile terminal suitable for the system of FIG. 1.

FIG. 8 is a flow chart illustrating a propitious information distribution system using a wireless mobile terminal according to a preferred embodiment of the present invention.

FIG. 9(a) is a diagram illustrating an example of propitious information as words information,

FIG. 9(b) is a diagram illustrating an example of propitious information as picture information.

FIG. 10(a) is a diagram illustrating an example of a displaying screen of future-telling information.

FIG. 10(b) is a diagram illustrating an example of displaying screen of a Shinto priest.

FIG. 10(c) is a diagram illustrating an example of displaying screen of a lucky charm.

FIG. 11(i a) is an example of a display screen for inputting the name of the bride and groom, and optionally, the date of their birthday and their blood types when simulating a marriage using a wireless terminal according to the present invention.

FIG. 11(i b) is an example of a display screen illustrating a Shinto priest, when simulating a marriage using a wireless terminal according to the present invention.

FIG. 11(i c) is an example of a display screen illustrating a marriage certificate, when simulating a marriage using a wireless terminal according to the present invention.

FIG. 12(i a) illustrates an example of a display screen used in fortune-telling practices.

FIG. 12(i b) is a diagram illustrating of a display screen of a sacred lot.

FIG. 13 is a diagram illustrating an example of a display form on a wireless mobile terminal showing a display associated with a prayer of enjoying good business.

FIG. 14(i a) illustrates an example of a display screen having inputted face photographs or portraits used in simulating marriage on wireless mobile terminal.

FIG. 14(i b) illustrates an example of a display screen having inputted face photographs or portraits of the bride and groom used in simulating a marriage on wireless mobile terminal.

FIG. 14(i c) illustrates an example of a display screen having inputted face photographs or portraits of the bride and grooms baby constructed from face photographs or portraits of the bride and bridegroom.

### DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

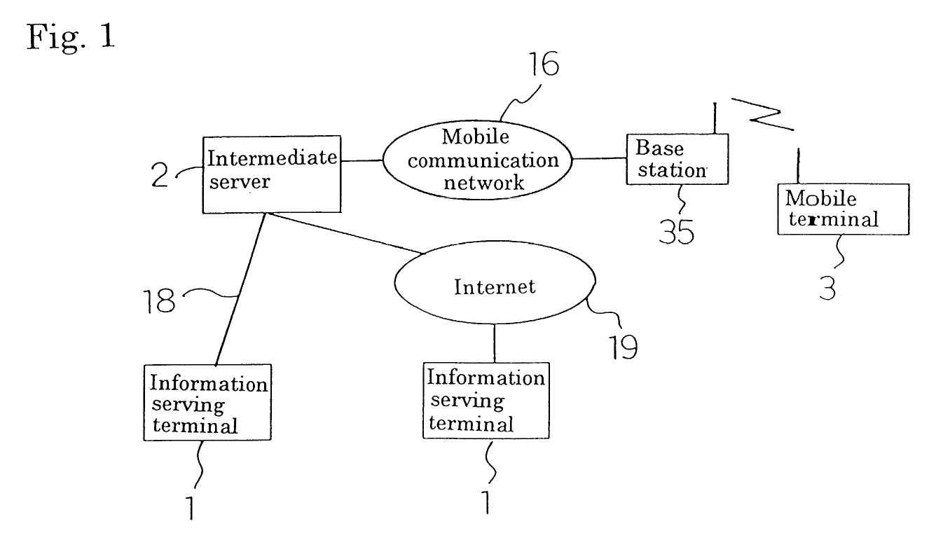

FIG. 1 is a system configuration diagram for showing a propitious information distribution system using a wireless mobile terminal according to the present invention.

The propitious information distribution system has an information serving terminal (1), an intermediate server (2) and a wireless mobile terminal (3).

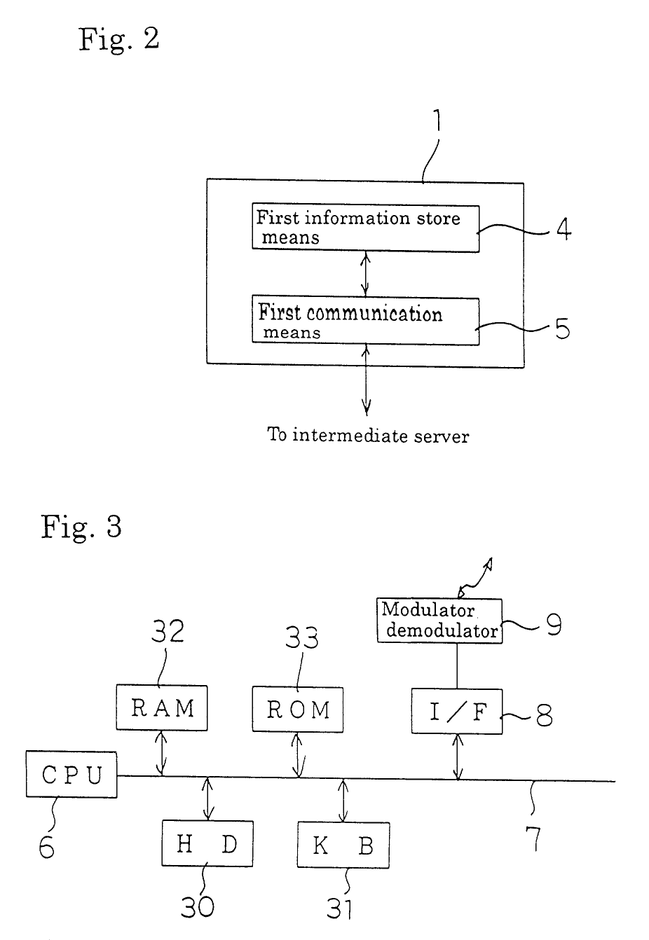

The information serving terminal (1) has a first information storing element (4) (see FIG. 2) for storing propitious information composed from characters and/or pictures associated with worship practices such as prayers implemented by a shrine or temple, and a first communication element (5) for transmitting the propitious information. The terminal is operated by the worship place.

Propitious information is defined as any type of information associated with worship practices, and imagined by worshipers as being helpful. For example, words or pictures representing an object of prayer to persons who visit a shrine or temple, or information of purifying words and pictures to a bride and bridegroom who are planning marriage. It should be understood that these examples are not limiting, and propitious information may include any information associated with worship practices. Additionally, it should be understood that any references to a marriage or a bride and groom should not be restricted to a bride and groom or a marriage in a legal sense, but also include people wishing to be married, imaging that they are married, contemplating marriage, or married according to their specific religious practices.

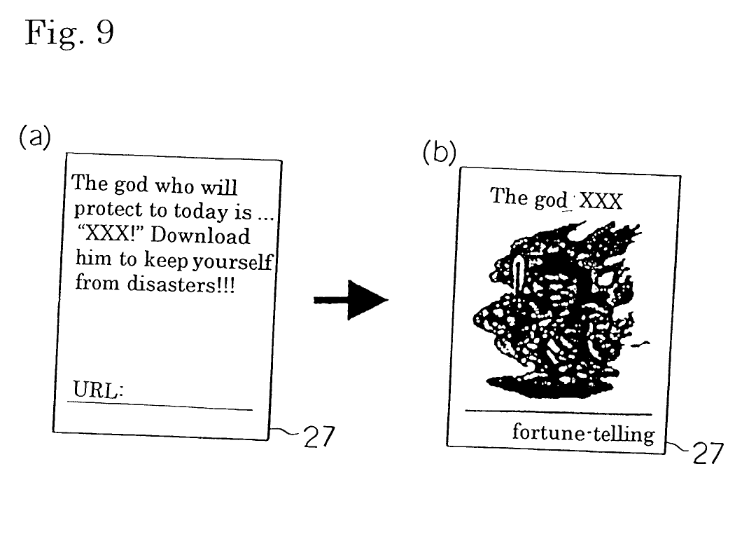

Examples of words which compose propitious information, include sutra citations which may be written in Chinese characters and/or Sanskrit characters, name of the gods and Buddha, purifying messages of a Shinto priest (see FIG. 9(i a)). Examples of pictures which compose propitious information include pictures of gods and Buddha (see FIG. 9(b)). Also, such pictures can adopt various forms of still pictures, animated cartoon such as animation and illustration. The purification of propitious information including words and pictures by shrines and temples lends reliability to their powers, according to the believes of the worshipers.

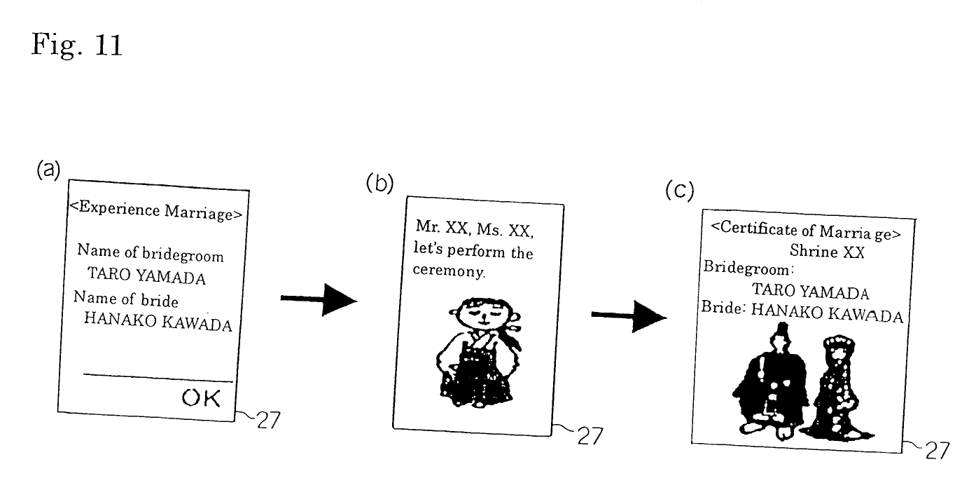

Additionally, propitious information may include sound information such as words as well as sound effects. Such sound information may accompany a visual display. For examples various entrance sounds may accompany an entrance scene of a picture of gods and Buddha (see FIG. 9(b)), or various entrance sounds, for example, a tinkle of a bell may accompany an entrance scene of a Shinto priest, for simulating a marriage (see FIG. 11) on a wireless mobile terminal (3). Another example includes transmitting a prayer of enjoying good business, with the words “EBISU SAMA” (believed to be a god of enjoying good business) to wireless mobile terminal (3) (see FIG. 13), including an entrance scene accompanied by various sounds such as falling coins, or a tune such as “Business prospers, come with bamboo grass!”

An information serving terminal (1) is controlled by a CPU (6) (see FIG. 3), a bus (7) is integrated with the CPU (6). A first information storing element (4) is constructed from a memory element that is connected with the bus (7). For example, it may cite external memory, such as hard disk (30) and CD-ROM.

A first communication element (5), for example, may be constructed from an interface (8) that is connected to a bus (7) and a modulator demodulator (9).

Further, in FIG. 3, a mark (31) comprises a keyboard for inputting various information, each of marks (32) and (33) are RAM and ROM comprising various recorded programs and information, such that the CPU (6) performs fixed operations.

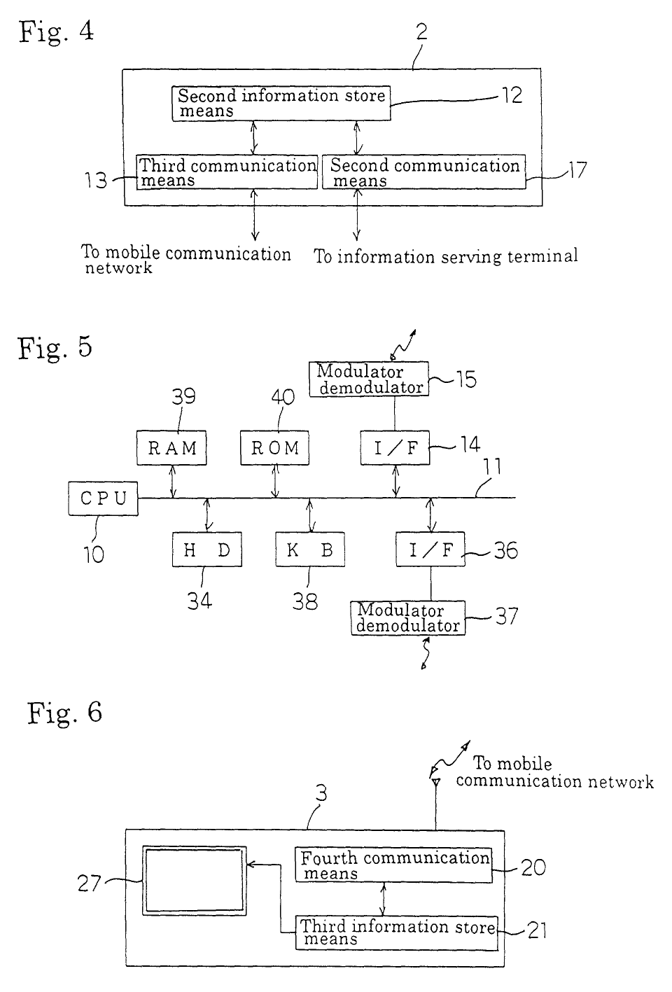

An intermediate server (2) (see FIG. 4) connects between a worship place such as shrine or temple which is the provider of propitious information and an owner of wireless mobile terminal (3) receiving the propitious information.

The intermediate server (2) has a second communication element (17) that receives propitious information from an information serving terminal (1), a second information storing element (12) that stores received propitious information, and a third communication element (13) wherein upon receiving a request signal for certain propitious information matching or associated with the propitious information stored in the second information storing element (12), the propitious information that adopts to this request signal is transmitted.

The intermediate server (2) is controlled by CPU (10) (see FIG. 5), and a bus (11) is integrated with the CPU (10). A second information store element (12) is constructed from memory that is connected to the bus (11). This memory, for example, may cite external memory such as hard disk (34) and CD-ROM.

A third communication element (13), for example, may be constructed from an interface (14) that is connected to a bus (11) and a modulator demodulator (15). The third communication element (13) is connected to a mobile wireless communication network (16) constructed from a telephone exchange, a central control station and a base station. A base station (35) of the communication network (16) is connected to a wireless mobile terminal (3) by wireless connection, and can exchange information between them.

A second communication element (17) can be a same composition with a third communication element (13), in figures, it is constructed from an interface (36) that is connected to a bus (11) and a modulator demodulator (37). The second communication element (17) is connected to an information serving terminal (1) through a private line (18) (see FIG. 1) or Internet (19).

Further, in FIG. 5, a mark (38) is a keyboard to input various kinds of information, each of a mark (39) and a mark (40) are RAM and ROM that are recorded various kinds of programs and information, so as to the CPU (10) functions fixed operations.

A wireless mobile terminal (3) is owned by a person who is to receive the propitious information. Such wireless mobile terminal may include a portable telephone which is carried by the person, or a PHS.

Generally, it is believed that good luck relating to matters such as traffic safety, passing the examination, safe delivery of a baby, prayer of marriage, wording off evil and a prayer for the New Year is obtained by always carrying a lucky charm (called a talisman) given by a shrine or temple for a fee.

The present invention enables such a charm to always be carried since a wireless mobile terminal such as a portable telephone or a PHS can always be carried in a handbag or a pocket. Therefore, those who believe in carrying lucky charms may also believe that carrying a wireless terminal having stored words or pictures associated with the charm may be equivalent to carrying the charm itself.

The wireless mobile terminal (3) has a fourth communication element (20) (see FIG. 6) wherein after a signal requesting propitious information has been transmitted, propitious information in response to this demand signal is received from an intermediate server (2) through the mobile wireless communication network (16), a third information storage elements (21) that stores received propitious information, and a display (27) that shows stored propitious information.

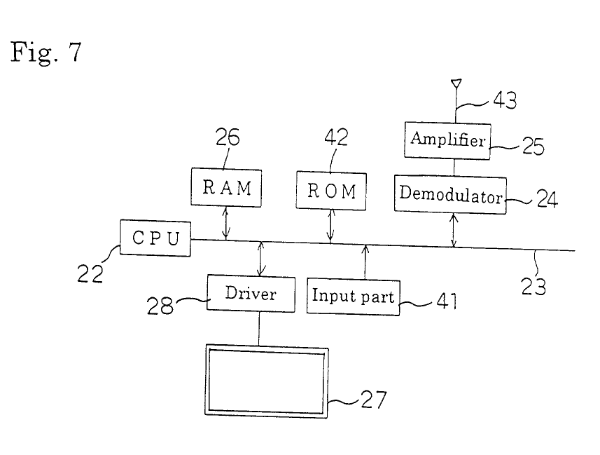

A wireless mobile terminal (3) is controlled by a CPU (22) (see FIG. 7), and a bus (23) integrated with the CPU (22). A forth communication element (20) can be constructed from a modulator (24), for example, that is connected to a bus (23), an amplifier (25), and an antenna (43). A third information storage element (21) is constructed from a memory that is connected to a bus (23). For example, this memory may be constructed from a RAM (26). A display (27) is connected to a bus (23) through a driver (28). This display (27) can show propitious information that is constructed from words, pictures, sounds, or a combination thereof, on demand.

Further, the wireless mobile terminal (3) has an input part (41). Command information against CPU (22) can be inputted from this input part (41). As such, after propitious information and names of shrines and temples providing the propitious information are inputted, signals requesting the propitious information may be transmitted.

Additionally, as shown in FIG. 7, a mark (42) is a ROM that is recorded various kinds of programs so as to the CPU (10) functions fixed operations.

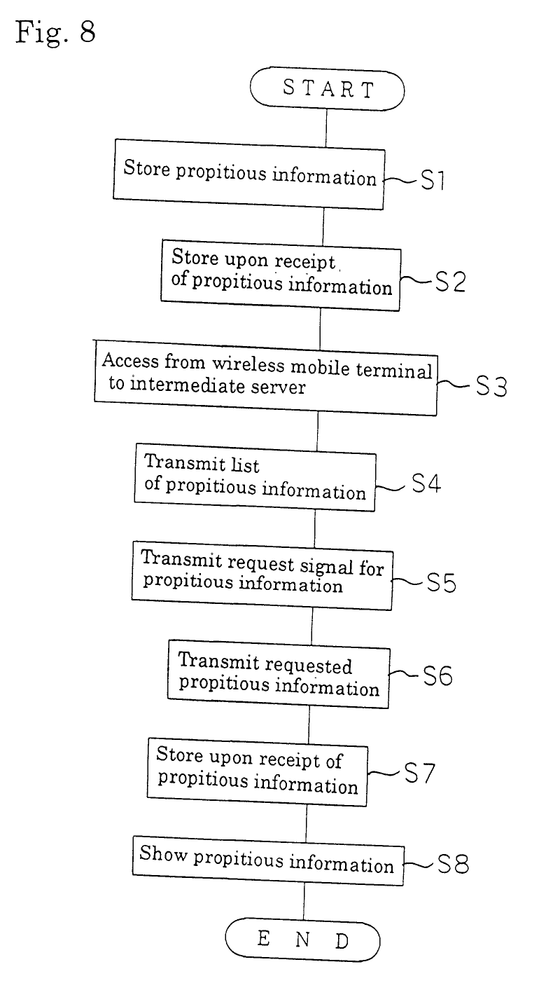

The operation of the propitious information distribution system will be explained based on a flow chart shown in FIG. 8.

First, propitious information consisting of words, pictures, sounds, or a combination thereof, offered by a worship place such as shrine and temple, is stored in a first information storage element (4) of an information serving terminal (1) (see FIG. 2) (Step 1). The propitious information stored in the first information storage element (4) is transmitted to an intermediate server (2) (see FIG. 4) and stored into a second information storage element (12) by the worship place (Step 2). In the second information storage element (12), various kinds of propitious information can be stored from many worship places through a private line (18) (refer to FIG. 1) or Internet (19).

A person who wants to be given propitious information can accesses the intermediate server (2) from a wireless mobile terminal (3) (see FIG. 1) (Step 3). A list of propitious information stored in the intermediate server (2) is transmitted into the wireless mobile terminal (3), and shown on a display (27) of the wireless mobile terminal (3) (refer to FIG. 6) (Step 4). A person seeking propitious information reads the list and selects a desired item of propitious information and a shrine or a temple for providing the propitious information. Finally, the person transmits the content of the selected information as a request signal into the intermediate server (2) (Step 5).

After the intermediate server (2) retrieves the propitious information corresponding to the request signal from the second information storage element (12), the retrieved propitious information is transmitted to the wireless mobile terminal (3) (Step 6). After the wireless mobile terminal (3) receives the propitious information, it stores it into a forth information storage element (21) (Step 7). The stored propitious information can be retrieved on demand and displayed (27) (Step 8).

In addition to these fundamental functions there are additional possible functions for the information distribution system. For example, in step 6, an intermediate server (2) can transmit information regarding the date of transmission and the period for which the propitious information is valid (some propitious information may only be valid for a fixed period of time after transmission) in addition to the propitious information itself. According to this example, in addition to propitious information, a wireless mobile terminal (3) stores information regarding the date of transmission and the period for which the propitious information is valid. Further, these dates can be displayed on demand. Consequently, the person receiving the information on his or her wireless terminal is reminded to update the information at a fixed period of time. The fixed period time is not necessarily restricted to a year. Any period of time for updating the information may be established such as one-week, one-month, half a year and one year.

Additionally, information warning of a closing update time may be transmitted and received by the wireless terminal. As such, the terminal may display the closing time for updating the information. This encourages the owner of a wireless mobile terminal (3) to update the information without missing the time deadline. Further, this allows the worship institutions to earn more money in updating fees, as the user is urged to update.

The propitious information stored in the first information storage element (4) can be updated by worship institution at a fixed period of time according to the periods mentioned above. After an owner of wireless mobile terminal (3) pays a renewal fee for the propitious information, the updated propitious information is transmitted to the wireless mobile terminal (3) through an intermediate server (2) and mobile wireless communication network (16). Therefore, an owner may update propitious information for a long period by paying a renewal fee for the propitious information to the worship place. Further, there is no need to visit the worship place every time the propitious information including the charm expires making it convenient for persons such as pregnant women or sick people that have difficulty in visiting the shrine or temple.

A wireless mobile terminal (3) that relates to the present invention is not particularly restricted to a mobile telephone such as portable telephone and PHS as mentioned above. For example, a car navigation terminal (not shown in figure), a mobile computer that has a portable telephone function, or a connected telephone, including a palm device capable of providing communication may be used.

A car navigation terminal which receives information regarding the car position from a satellite, shows a map, taken from a map information storage memory on a display, marks the car position on the map that is shown, and navigates the car from its current position to the destination by sending messages from a speaker with the moving car position displayed on the map, according to location of the moving car.

A propitious information distribution system, according to present invention, can be operated by connecting such car navigation terminal to the above mentioned mobile wireless communication network (16) by a wireless connection, making it possible to transmit propitious information from the intermediate server (2) to a car navigation terminal. There are many ways for establishing a wireless connection. For example, mobile telephones such as portable telephones can be used. In this case, wireless communication (16) can be executed with an intermediate server (2) by connecting mobile telephones to a modulator demodulator which is loading in car navigation terminal.

When the car navigation terminal serves as the wireless mobile terminal, propitious information received from the intermediate server (2) can be stored in a memory of the car navigation terminal, and the installed information can be shown on the display of the car navigation terminal, on demand.

As a car navigation terminal is mounted in cars, storing propitious information in a car navigation terminal can serve the same purpose as having a lucky charm for safe driving, according to some beliefs.

Further, according to the present invention, information offered by worship places such as shrines or temples may also include sacred lot information and/or fortune-telling information.

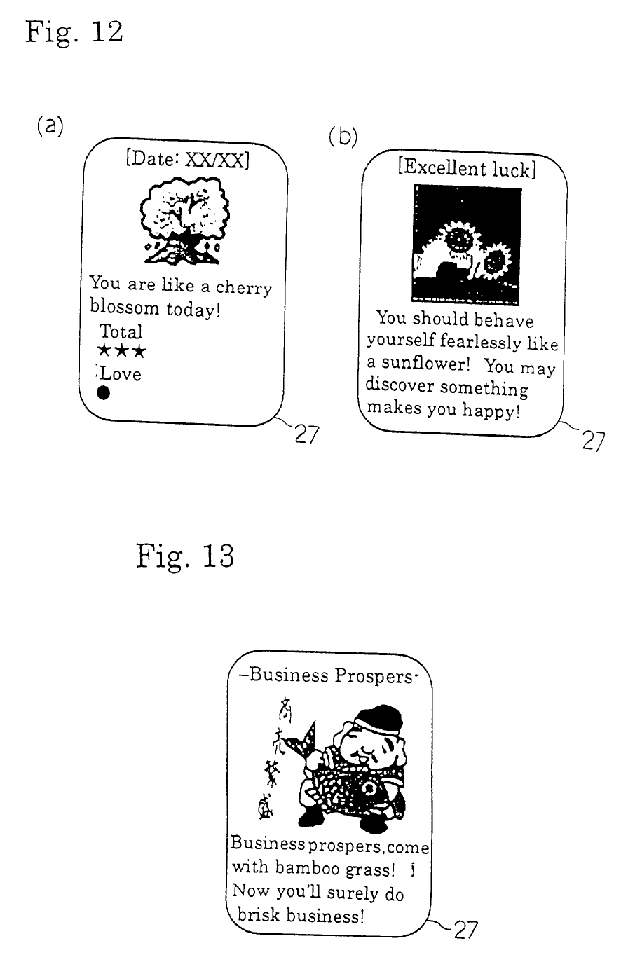

The form of transmission for sacred lot information according to the present invention is not restricted to a particular embodiment. For example, information regarding good and bad luck may be transmitted to a wireless mobile terminal (3) through an intermediate server (2), by pressing a sacred lot button on the wireless terminal (3). Subsequently, A picture of a sunflower may appear on the terminal accompanied by words information such as “The day which you can be feel like a sunflower” (see FIG. 12(b)).

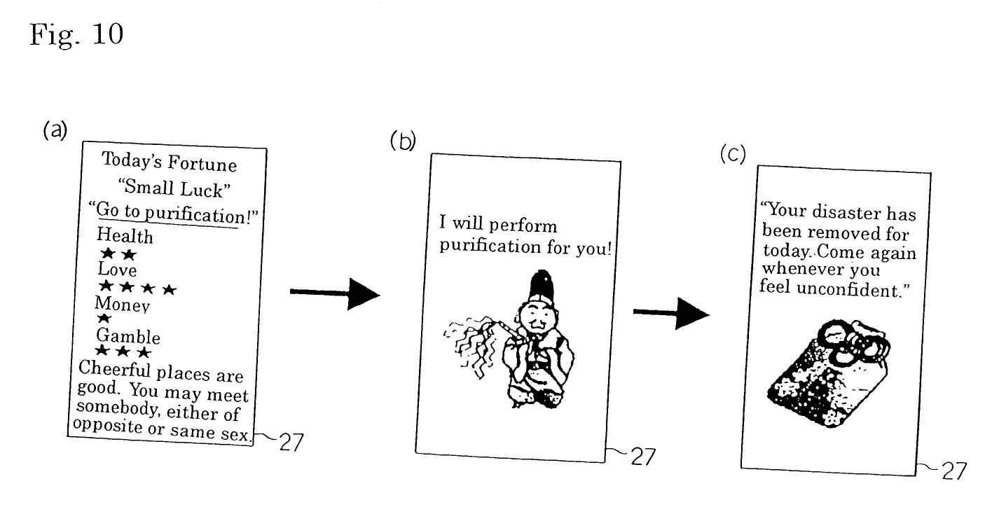

Further, transmission of fortune-telling information in this invention is not restricted particularly. For example, when the date of user's birthday is inputted into the wireless mobile terminal (3), all kinds of fortune-telling information such as whole fortune, love fortune, health fortune and gamble fortune, can be transmitted to the wireless mobile terminal (3) through the intermediate server (2). A wireless mobile terminal can be constructed for displaying different kinds of fortunes by number of star, animals (for example, faces) and plants (for example, flowers) etc (see FIG. 12(i a) and FIG. 10(a)).

Besides transmitting propitious information a system according to the present invention, can transmit information of sutra and posthumous Buddhist names for dead persons in addition to above mentioned propitious information. The configuration and the function of the relevant transmitting system are explained below.

A wireless mobile terminal (3) (in this case, mobile telephones such as portable telephones) and information serving terminal (1) are constructed so as to transmit mutually through the above mentioned transmission elements. Further, in the first information storage element (4) of the information serving terminal (1), sutra sound information are stored in addition to the above mentioned propitious information. A sutra request signal is transmitted from a wireless mobile terminal (3) to the information serving terminal (1). Then sutra sound information for this sutra request signal is transmitted to a wireless mobile terminal (3). The transmitted sutra sound information is stored in the third information storage element (21) of the wireless mobile terminal (3), and is outputted from the speaker of the wireless mobile terminal (3) on demand.

Such propitious information distribution system may function as follows:

First, upon the death of a relative, the bereaved family can access the information serving terminal (1) of a temple through the intermediate server (2) from the wireless mobile terminal (3) and apply for his/her posthumous Buddhist name. A Buddhist priest decides a posthumous Buddhist name according to the application, and transmits to the wireless mobile terminal (3) through the intermediate server (2). After receiving the posthumous Buddhist name, the wireless mobile terminal (3) stores the posthumous Buddhist name in the third information storage element (21).

When a Buddhist service is held (i.e. on the seventh day and the forty-ninth days after his/her death, first and third year anniversary of his/her death, and especially at the equinoctial week and the Bon festival), a user can access the information serving terminal (1) through the intermediate server (2) from the wireless mobile terminal (3) and transmit a request signal for requiring the transmission of sutra in advance. According to this system, sutra sound information may be transmitted to the wireless mobile terminal (3) through the intermediate server (2) on the day of holding a memorial service. After the wireless mobile terminal (3) receives this sutra sound information, it stores this information in the third information storage element (21), and outputs the sutra sound from speakers on the wireless mobile terminal (3) at the start of the memorial service.

The term of the equinoctial week and the Bon festival are the busiest time for Buddhist priests in a year, and some of them have to visit nearly 100 houses in a day. However, if a propitious information transmitting system according to the present invention is used, instead of a Buddhist priest visiting the supporter's house and reading sutra, a supporter of a Buddhist temple or a part-timer can bring a wireless mobile terminal (3) to the house, and listen to the sutra from the speaker of a wireless mobile terminal (3). This can lessen the burden of the Buddhists priests.

Additional embodiments can be added in the propitious information transmitting system according to the present invention. For example, for solving modern social problems such as juvenile delinquencies, suicides and coming to believe in cult religions, shrines and temples are used for counseling. Priests of shrines and temples offering traditional Japanese enlightenment can offer help.

First, a person wishing to get counseling can accesses an information serving terminal (1) through an intermediate server (2) from wireless mobile terminal (3) (in this case, mobile phones such as portable telephones), and send an e-mail regarding the details of his worries. A Buddhists priest can read the e-mail message and write a return mail, sending it to wireless mobile terminal (3) through intermediate server (2). After having received the return message, wireless mobile terminal (3) stores this in the third information storage element (21). The person seeking counseling retrieves the return message and confirms it.

Further, according to the present invention, as mentioned above the intermediate server (2) transmits sacred lot information and/or fortune-telling information for daily fortune-telling to the wireless mobile terminal (3) which receives propitious information, and shows the information to display (27) of wireless mobile terminal (3).

For an intermediate server transmitting sacred lot information and/or fortune-telling information, it is preferable that intermediate server (2) can also transmit purification information to the wireless mobile terminal (3) which received sacred lot information and/or fortune-telling information on demand (see FIG. 10(b)). The transmission of purification information, may be desired in case the received sacred lot information and/or fortune-telling information is negative. By sending purification information to the wireless mobile terminal (3) from the intermediate server (2), the user of the wireless mobile terminal (3) can feel relieved. An example of a display screen showing purification information includes a lucky charm as shown if FIG. 10(c).

Fortune-telling and sacred lot can be done by supplying personal information including name, birthday, blood type, and/or gender by the user of the wireless mobile terminal (3) to the intermediate server (2) in advance, or at the time the fortune-telling and a sacred lot is performed.

Purification information displays may also include, word message and diagrams (see FIG. (10)) showing a Shinto priest or a gods and Buddha purifying.

It is also possible to simulate a marriage by using the intermediate server (2) (see FIG. 11). In this case, the intermediate server (2) transmits a screen having inputted information comprising the name of the bride and bridegroom, their birthdays and their blood types to the wireless mobile terminal (3), the screen is shown in the display (27) of wireless mobile terminal (3) (see FIG. 1 1(a)), intermediate server (2) transmits the purification message for from a Shinto priest after receiving the name of the bride and bridegroom, the birthday and the blood type from the wireless mobile terminal (3) (see FIG. 11(b)), then transmits the marriage certificate to the wireless mobile terminal (3) (see FIG. 11(c)).

The, intermediate server (2) may also require that the bride and groom make a marriage vow through the wireless mobile terminal (3) and transmit the purifying message only if the vow is made.

The intermediate server (2) can transmit a diagram information which shows the situation of purification by a Shinto priest or the gods and Buddha (see FIG. 11(b)) with a purification message.

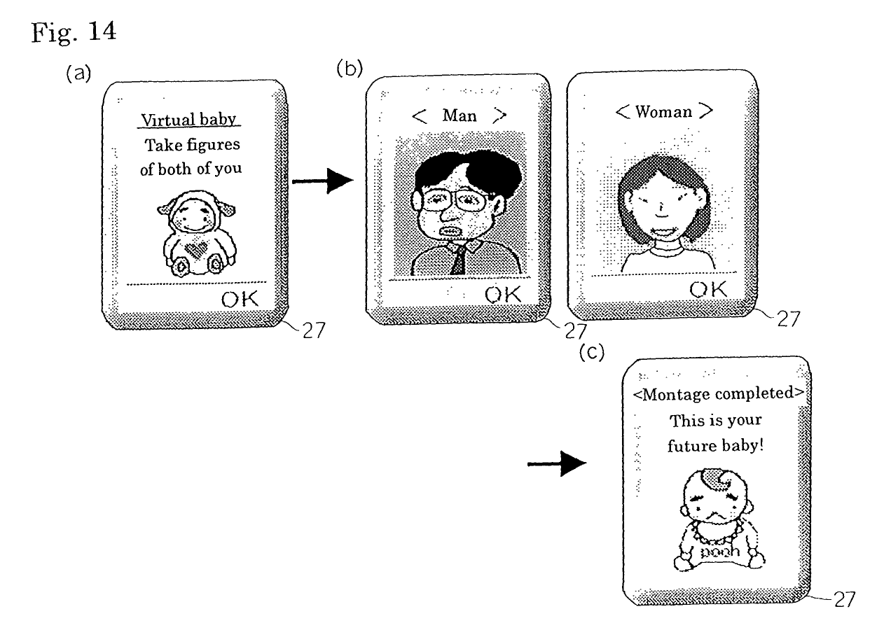

For a simulated marriage, it is preferable that the wireless mobile terminal (3) can download each face photographs and portraits of the bride and bridegroom (refer to FIG. 14(a), (b)), and can transmit the information of face photographs and portraits to the intermediate server (2). The intermediate server (2) can also preferably compose a face photograph or a portrait of a baby who will be born to the bride and bridegroom based on the information of face photographs or portraits, transmit the information of face photographs or portraits to the wireless mobile terminal (3). The information of face photographs or portraits of a baby transmitted to wireless mobile terminal (3) is shown in the display (27) of FIG. 14(c).

A camera that is part of the wireless mobile terminal (3) or the user's own digital camera can be used to download face photographs.

Information regarding predictions of the character of the children to be born to the bride and bridegroom may also be transmitted to the terminal, based on the birthday and the blood type of the bride and bridegroom, and other possible information, which is received from the terminal (3).

Additionally, a prayer for business prosperity may be done on a wireless mobile terminal (3) (see FIG. 13). For example, from intermediate server (2) the figure of “EBISU SAMA” which is believed to be a god associated with enjoying good business, may be transmitted to the wireless mobile terminal (3) as propitious information, and the figure of “EBISU SAMA” may be displayed in wireless mobile terminal (3). In the case of displaying the figure, a message may accompany the figure such as “Propitious business˜Now you'll surely do brisk business.”

Another example of propitious information includes a prayer for traffic safety which displays the figure of “Fudo of mountain” which is believed to be a god for traffic safety. Also the figure of “Fudo of mountain” may be displayed in a wireless mobile terminal (3). This display may be accompanied by a message such as “Driving safely with good care of you after this! Leave up for a year.”

Furthermore, a prayer for marriage may also be give. For example, this may include the believed god for marriage or a figure of “a maiden in the service of a shrine” which is transmitted and displayed by the wireless mobile terminal (3). The figure may be accompanied by a message such as “Hope to get along with wonderful partner! Hope to be happy!”

While the present invention has been described with regards to particular embodiments, it is recognized that additional variations of the present invention may be devised without departing from the inventive concept.

What is claimed is:

1. A propitious information distribution system comprising: an information serving terminal operated by a worship place for storing and transmitting propitious information, and a wireless terminal for receiving the propitious information.

2. The system of claim 1 wherein said propitious information comprises words, sounds, visual images, or a combination thereof.

3. The system of claim 1 wherein said propitious information relates to worship practices, said information believed by worshipers to be helpful.

4. The system of claim 1 wherein said propitious information relates to charms, omens, prayers, or rituals practiced by religious observers.

5. The system of claim 1 wherein said propitious information relates to worship practices of Buddhism.

6. The system of claim 1 wherein said worship place includes a shrine or temple.

7. The system of claim 1 wherein said propitious information is prayed for at the worship place before it is transmitted.

8. The system of claim 1, further comprising an intermediate server for receiving information from the serving terminal, storing the information received from the serving terminal, and transmitting the information to the wireless terminal upon request specifying the desired information.

9. The system of claim 1 wherein said serving terminal comprises a first information storage element into which propitious information is stored.

10. The system of claim 9 wherein said serving terminal further includes a first communication element for transmitting the propitious information.

11. The system of claim 10, further comprising:
an intermediate server having a second communication element for receiving the propitious information form the serving terminal, and
a second information storage element for storing the received information ,and
a third communication means for sending the information to the wireless terminal upon receipt of a request signal, said request signal designating the desired item of information selected from propitious information stored in the second information storage element.

12. The system of claim 11, wherein said wireless terminal comprises:
a fourth communication element for sending the request signal to the intermediate server and for receiving propitious information from the intermediate server,
a third information storage element for storing the received information, and
a display for displaying the stored information.

13. The system of claim 1, wherein said wireless terminal is a mobile telephone, a mobile computer, a palm device, or a car navigation terminal.

14. The system of claim 1, wherein propitious information stored in said serving terminal is updated periodically.

15. The system of claim 14, further comprising an intermediate server which can be accessed by the wireless terminal, wherein propitious information and updated propitious information is sent to and stored by the intermediate server.

16. The system of claim 15, wherein said propitious information and updated propitious information can be downloaded to the wireless terminal upon payment of a fee by the wireless terminal user.

17. The system of claim 16, wherein upon downloading propitious information, said user also receives information regarding the period for updating the information.

18. The system of claim 17, wherein said user receives reminders regarding the time period for updating the information.

19. The system of claim 1 wherein said propitious information includes sacred lot information, fortune-telling information, or a combination thereof.

20. The system of claim 19 wherein purification information can be sent, following the sending of sacred lot information.

21. The system of claim 1 wherein said server further transmits an input screen to the wireless mobile terminal for inputting personal information to be provided by the wireless terminal user.

22. The system of claim 21 wherein said personal information includes the names, birthdays, and blood types of two people wishing to simulate a marriage.

23. The system of claim 21 wherein said personal information is sent back to the server or an intermediate server, and wherein said personal information is used to generate a message based on the personal information, said message to be sent back to the wireless terminal user.

24. The system of claim 23 wherein said message may include a marriage certificate and a purification message from a Shinto priest, or a combination thereof.

25. The system of claim 23 wherein said message includes information predicting the personality of a child which will be born to the two people.

26. The system of claim 1 wherein two people wishing to simulate a marriage may send pictures of themselves through the wireless terminal, and receive a message back from the server or an intermediate server relating to their marriage.

27. The system of claim 26 wherein said message includes a picture predicting the appearance of a child that will be born to the two people.

28. The system of claim 26 wherein said message includes information predicting the personality of a child which will be born to the two people.

29. A method for distributing propitious information comprising:
providing a main server for storing and transmitting information by a worship place, and
accessing and receiving said information on a wireless terminal.

30. The method of claim 29 further comprising providing an intermediate server for receiving information form the main server, said intermediate server being capable of being accessed by the wireless terminal for receiving requests from the terminal, and for transmitting information to the terminal.

31. The method of claim 29 wherein said propitious information relates to worship practices, and charms, omens, prayers, or rituals practiced by the worshipers.

32. A propitious information distribution system comprising:
information serving means operated by a worship place comprising means for storing and transmitting propitious information, and
wireless means for receiving the propitious information.
